(19) United States
(12) Patent Application Publication
(10) Pub. No.: US 2025/0117646 A1
(43) Pub. Date: Apr. 10, 2025

(54) SUSTAINABLE TRAINING OF ARTIFICIAL INTELLIGENCE AND MACHINE LEARNING MODELS

(71) Applicant: Cisco Technology, Inc., San Jose, CA (US)

(72) Inventors: Raghu Rajendra Arur, Dwarka (IN); Indermeet Singh Gandhi, San Jose, CA (US)

(21) Appl. No.: 18/481,011

(22) Filed: Oct. 4, 2023

(51) Int. Cl. G06N 3/08

(52) U.S. Cl. CPC G06N 3/08

(57) ABSTRACT

Methods are provided for sustainably training artificial intelligent or machine learning models. Specifically, the methods involve obtaining power supply information about at least two computing resource groups. The power supply information relates to one or more power sources that supply power to the at least two computing resource groups. The methods further involve determining, while training an artificial intelligence or machine learning model using a current computing resource group of the at least two computing resource groups, an availability of power provided to the current computing resource group from one or more renewable energy sources, based on the power supply information and migrating the artificial intelligence or machine learning model for training using a different computing resource group than the current computing resource group, based on determining a lack of the availability of power provided to the current computing resource group from the one or more renewable energy sources.

### TECHNICAL FIELD

The present disclosure generally relates to computer networks and systems.

### BACKGROUND

Artificial intelligence and machine learning (AI/ML) models have become mainstream technologies especially for large enterprises. AI/ML models provide enterprises with insights to increase their top-line. To be useful, AI/ML models are continuously trained. Training these AI/ML models is computationally costly and energy consuming. In other words, training AI/ML models uses significant power. They are some of the most power-hungry jobs that are being deployed by or for enterprises. While AI/ML models are useful, sustainability and carbon footprint are also factors that enterprises consider in operations and to increase their top-line.

### BRIEF DESCRIPTION OF THE DRAWINGS

FIG. 1 is a diagram of an environment in which time-series energy baselines are generated based on power supply information, according to an example embodiment.

FIG. 2 is a diagram illustrating an environment in which a sustainability service determines whether to migrate the artificial intelligence or machine learning model for training from a current computing resource group to a different computing resource group, according to an example embodiment.

FIG. 3 is a flowchart illustrating a method of determining, by a sustainability service, whether to continue training of an artificial intelligence or machine learning model at a current datacenter based on availability of power from one or more renewable energy sources, according to an example embodiment.

FIG. 4 is a flowchart illustrating a method of migrating an artificial intelligence or machine learning model for training using a different computing resource group based on a lack of availability of power provided to a current computing resource group from one or more renewable energy sources, according to an example embodiment.

FIG. 5 is a hardware block diagram of a computing device that may perform functions associated with any combination of operations in connection with the techniques depicted and described in FIGS. 1-4, according to various example embodiments.

### DETAILED DESCRIPTION OF EXAMPLE EMBODIMENTS

### Overview

Techniques presented herein provide for training artificial intelligent or machine learning models by selecting one of computing resource groups that is being powered by renewable energy source(s) at the time of training.

In one form, the methods involve obtaining power supply information about at least two computing resource groups. The power supply information relates to one or more power sources that supply power to the at least two computing resource groups. The methods further involve determining, while training an artificial intelligence or machine learning model using a current computing resource group of the at least two computing resource groups, an availability of power provided to the current computing resource group from one or more renewable energy sources, based on the power supply information. The methods further involve migrating the artificial intelligence or machine learning model for training using a different computing resource group than the current computing resource group, based on determining a lack of the availability of power provided to the current computing resource group from the one or more renewable energy sources.

### EXAMPLE EMBODIMENTS

Artificial intelligence or machine learning (AI/ML) models are commonly deployed by enterprises to help with enterprise tasks and to gain various insights. Some non-limiting examples of AI/ML models include unsupervised machine learning, supervised machine learning, deep neural networks, large language models (LLMs) such as recurrent neural networks, generative pre-trained transformers (GPT), bidirectional encoder representations from transformers (BERT), text-to-text transfer transformers (T5). AI/ML models are trained using specialized hardware such as graphic processing units (GPUs) and/or tensor processing units (TPUs).

Training AI/ML models is a costly endeavor. It is computationally heavy and consumes a large amount of energy. For example, training a large LLM model may involve thousands of GPUs and take months to train and deploy. Moreover, faster training of the AI/ML models uses more computing resources, which means more energy or power. Using more energy means a larger carbon footprint i.e., higher carbon dioxide (CO2) emissions. Meanwhile, enterprises are trying to reduce their carbon footprint. Sustainability is a factor that enterprises consider in running their operations.

The techniques presented herein reduce the carbon footprint in training AI/ML models by intelligently determining a computing resource group that is being powered by renewable energy (power from renewable energy sources) at the time of training. As such, the AI/ML model may be trained using several computing resource groups by intelligently migrating the AI/ML model to a different computing resource group to continue training based on sustainability metrics.

The techniques presented herein use time-series nature of energy or power sources that supply power to computing resource groups such as data centers that may be spread across geographies. The techniques presented herein use checkpointing, which involves stopping the training, recording a state of the AI/ML model e.g., neural network, and resuming where the training was left off. Specifically, using checkpointing and the fact that enterprises have computing resource groups in different regions where the source of power supply is different at different times of the day, for example, the AI/ML model may be migrated to a different computing resource group. The techniques presented herein allow enterprises to take advantage of renewable energy sources such as wind, solar power, etc., which may be more abundant in certain regions at certain times of the day and run the power hungry training jobs (training AI/ML models) in these locations (sites or data centers) to reduce the carbon footprint. As such, enterprises train the AI/ML models in a sustainable way to reduce their carbon footprint in comparison to training these power intensive AI/ML models at the same location.

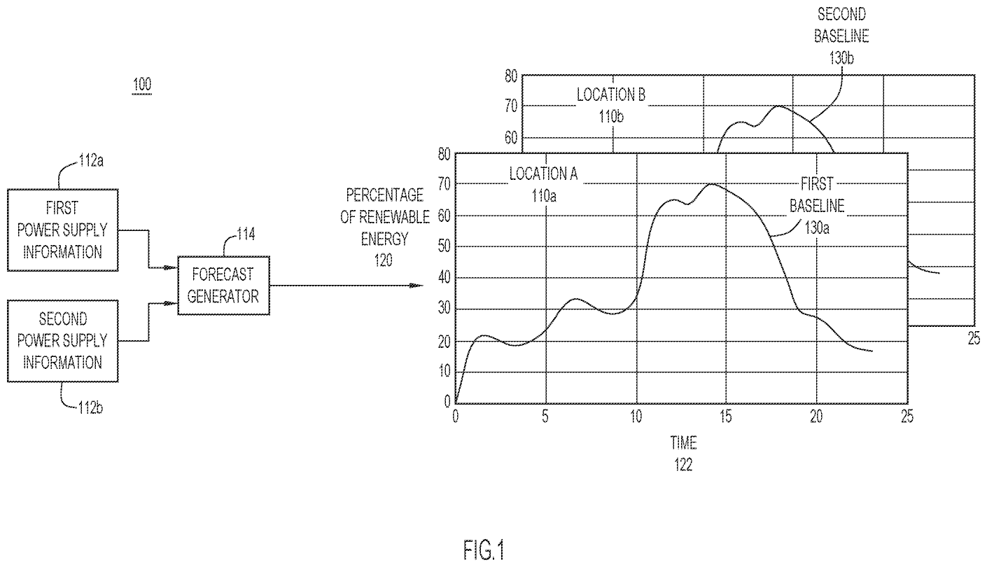

FIG. 1 is a diagram of an environment 100 in which time-series energy baselines are generated based on power supply information, according to an example embodiment. The environment 100 includes first power supply information 112a for a computing resource group at a location A 110a, second power supply information 112b for a computing resource group at a location B 110b, a forecast generator 114 that generates time-series energy baselines 130a-b for computing resource groups such as a first baseline 130a for the location A 110a and a second baseline 130b for the location B 110b.

The notations 1, 2, 3 . . . n; a, b, c, . . . n; “a-b”, “a-n”, “a-f”, “a-g” “a-k” “a-c”, and the like illustrate that the number of elements can vary depending on a particular implementation and is not limited to the number of elements being depicted or described. Moreover, these are only examples of various components, and the number and types of components, functions, etc. may vary based on a particular deployment and use case scenario. For example, the environment 100 may involve any number of computing resource groups at various geographically remote locations. The environment 100 may further involve one distributed data center with multiple enterprise sites and/or multiple data centers. The components in the environment 100 will vary based on a particular deployment and use case scenario.

A computing resource group includes hardware for training and/or deploying AI/ML models such as graphics processing units (GPUs) and/or tenson processing units (TPUs). A computing resource group hosts network and computing equipment for training and/or deploying AI/ML models e.g., servers in a data center. In one example embodiment, computing resource groups are geographically remote enterprise sites of a distributed data center. Each geographically remote enterprise site includes GPUs and/or TPUs. In another example embodiment, computing resource groups are different data centers that host network and computing equipment for performing hosting and computing functions such as training and/or deploying AI/ML models. In yet another example embodiment, computing resource groups may be a set of specialized hardware that are in the same location but powered by different energy sources. These are only examples of computing resource groups, and the number and types of components, functions, etc. of computing resource groups may vary based on a particular deployment and use case scenario. For example, computing resource groups may belong to different enterprises e.g., two different service providers.

The power supply information 112a-b is data related to power sources for a particular computing resource group. In one example embodiment, the first power supply information 112a is for a different geographic location than the second power supply information 112b e.g., the first power supply information 112a relates to the location A 110a of a first computing resource group and the second power supply information relates to the location B 110b of a second computing resource group. The location A 110a and the location B 110b may be different enterprise sites of a distributed data center or different data centers e.g., one located in San Jose, CA and another located in Austin, TX.

The power supply information 112a-b is obtained from an external entity such as energy information brokers, electricity map services, a knowledge base, a third party energy information provider, etc. but is not limited thereto. The power supply information 112a-b may also be input by a user.

The power supply information 112a-b may be in a form of amount of energy supplied e.g., megawatts (MW) at various times e.g., one minute, five minutes, one hour intervals, etc. but is not limited thereto. In one example embodiment, the energy breakdown may be by percentages and/or at a particular point in time. In general, power supplied to a computing resource group such as a datacenter or an enterprise site (a particular location), is a mixture of energy or power from various power sources.

Power supply sources include renewable power sources and non-renewable energy or power sources. Non-renewable power sources may be natural gas, large hydro, imported power, battery, nuclear power, coal, etc. The renewable energy sources may be solar, wind, geothermal, biomass, biogas, small hydro, etc. Combination of these various power sources that supply power to a computing resource group may vary over time within a day and over days within a year, for example. In California (e.g., at the location A 110a), the day's supply of power is mostly from renewable energy sources and during the night, non-renewable power sources are mostly used to power the region.

In one or more example embodiments, the granularity of the power supply information 112a-b varies depending on the external entity used and use case scenario. For example, the power supply information 112a-b may indicate that at 7:15 am (point in time), at a target location, renewable energy sources supplies 13,035 MW, natural gas energy sources (non-renewable) supplies 4,038 MW, large hydro energy sources (non-renewable) supplies 3,115 MW, and nuclear energy sources (non-renewable) supplies 2,264 MW, etc. Additionally, the power supply information 112a-b may indicate power supplied from various renewable energy sources e.g., 5,520 MW is supplied by a solar energy source, 3,612 MW is supplied by a wind energy source, etc. In one example embodiment, the power supply information 112a-b may indicate percentage of power from renewable energy sources versus non-renewable power sources by months, weeks, days, hours, minutes, etc.

In one example embodiment, multiple energy brokers may be used to obtain the power supply information 112a-b. External entities typically provide application programming interfaces (APIs) to query the combination of power sources and/or percentages at any given point in time of the day and/or month. A sustainability service performs one or more API calls to an external entity (one or more energy brokers) to obtain data about a portion of a total power supplied by each of a plurality of power supply sources that power a respective computing resource group (e.g., a target location).

Apart from getting power supply data from an external entity, a user may input the energy source supply as a time-series if they have the information or input information about the external entity that can provide a time-series view of the combination of energy sources at each geographical location of a distributed data center at a particular point in time.

The power sources that supply power to a particular geographical location e.g., a computing resource group, may be seasonal but this is just an example. When the data is seasonal, the forecast generator 114 baselines the data and predicts power use for hours and/or days in the future. In one example embodiment, the forecast generator 114 uses Fast Fourier Transform (FFT) and fb-prophet to generate baselining (the first baseline 130a and the second baseline 130b) that predicts the combination of energy sources at a given point in time and at a given day. Both FFT and fb-prophet are efficient algorithms, which take negligible time to train and predict. The first baseline 130a and the second baseline 130b may be in a form of percentage of renewable energy 120 plotted against time 122. The renewable energy 120 may be plotted in 5 minutes time intervals, in hour intervals, etc.

By generating the first baseline 130a and the second baseline 130b, computational cost of a sustainability service that determines an optimal location/computing resource group for training AI/ML models, is reduced. If forecasting is not performed (the forecast generator 114 is not used), then an external entity is queried every time a determination is to be made, using API calls. However, each API call is an additional computational cost and frequent API calls to the external entity may increase the computational cost of the sustainability service.

For example, leveraging that power supply information is seasonal, using the forecast generator 114 reduces the number of API calls involved and reduces the computational cost for the sustainability service. If the data is not seasonal, then baselining and prediction may not necessarily work and API calls are more frequent. However, seasonality and time of day are only example parameters for baselining. The forecast generator 114 may detect other patterns and/or parameters for baselining power supply information. In one example embodiment, the sustainability service may analyze power supply information related to at least two computing resource groups to determine whether to invoke the forecast generator 114. If a pattern cannot be detected, the sustainability service uses API calls when needed. If a pattern is detected, the forecast generator 114 is invoked to generate the first baseline 130a and the second baseline 130b.

Using the power supply information 112a-b for at least two computing resource groups (e.g., various locations of a distributed data center), the sustainability service determines sustainability metrics to use in determining whether to migrate training of AI/ML models to a different computing resource group e.g., when an amount of total renewable energy falls below a predetermined threshold value or when it is lower than total renewable power available at the different computing resource group.

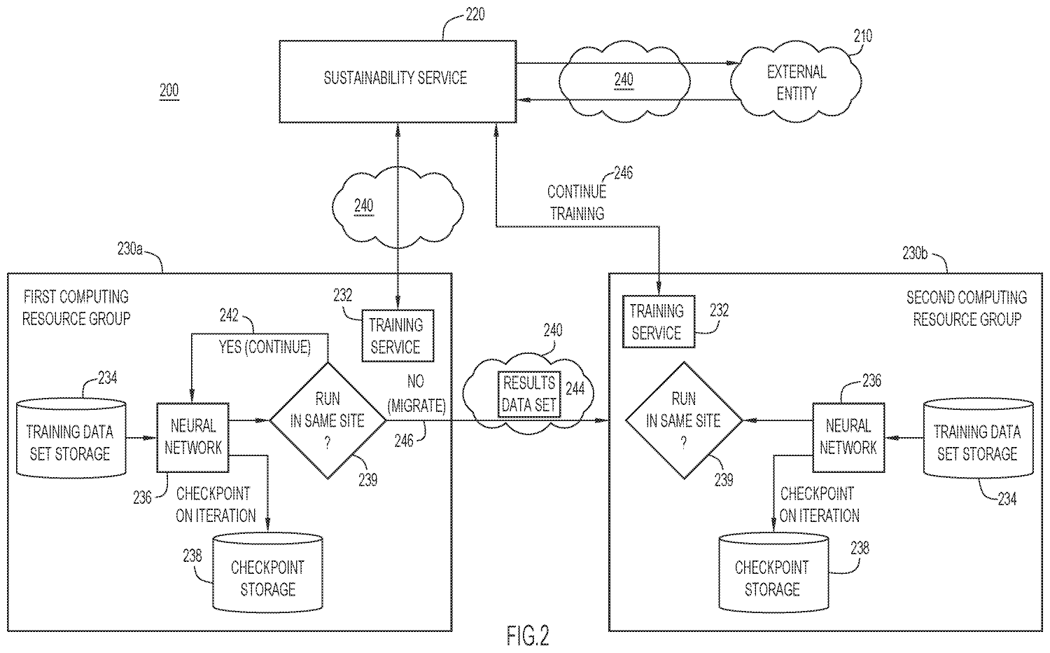

With continued reference to FIG. 1, FIG. 2 is a diagram illustrating an environment 200 in which a sustainability service determines whether to migrate the artificial intelligence or machine learning model for training from a current computing resource group to a different computing resource group, according to an example embodiment. The environment 200 includes an external entity 210, a sustainability service 220, a first computing resource group 230a, a second computing resource group 230b, and network(s) 240.

The external entity 210, the sustainability service 220, the first computing resource group 230a, and the second computing resource group 230b, communicate with one another via the network(s) 240. The network(s) 240 include one or more networks such as, but not limited to, local area network (LAN), wide area network (WAN) (e.g., the Internet). The network(s) 240 is a network infrastructure that enables connectivity and communication between entities in the environment 200.

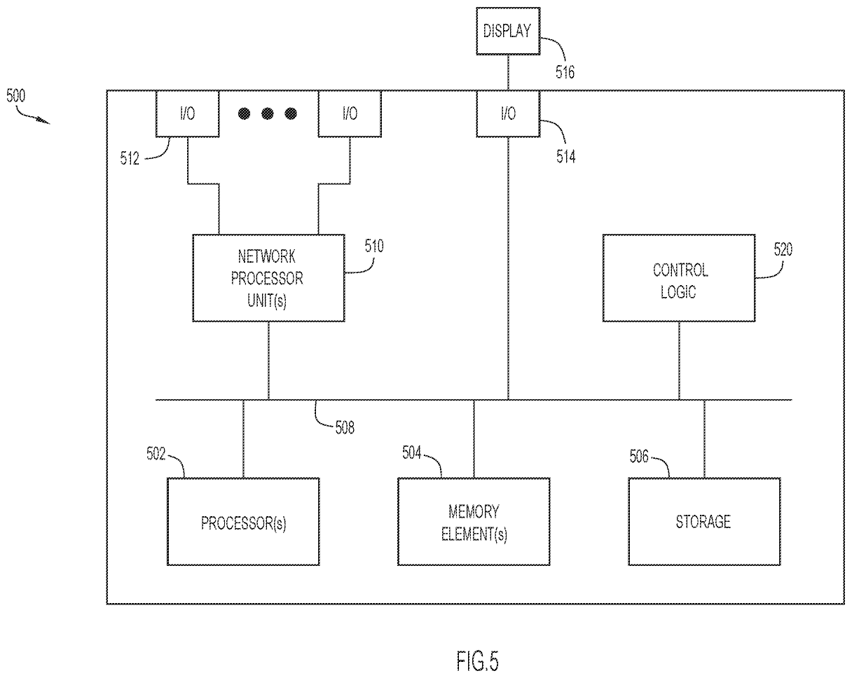

The external entity 210 stores power supply information (such as the first power supply information 112a and the second power supply information 112b of FIG. 1) about power sources for various geographic areas (such as the location A 110a and the location B 110b of FIG. 1). The external entity 210 may be an external energy broker that includes one or more computing devices of FIG. 5 and databases that store historical data trends of power sources that supply power and/or data about power sources that currently power the computing resource group. For example, the external entity 210 provides percentages or amounts of power from multiple power sources with a minute-by-minute granularity using an API. The external entity 210 may be a service in which users input power supply information i.e., time-series energy supply, for each of the first computing resource group 230a and the second computing resource group 230b. The external entity 210 provides the power supply information for each computing resource group (e.g., each of enterprise data centers and/or locations of the distributed data center) to the sustainability service 220.

The sustainability service 220 may be implemented on one or more computing devices of FIG. 5 configured to process data, host applications, and communicate with other entities in the environment 200 using the network(s) 240. The sustainability service 220 may be in a form of a software product that resides in an enterprise network and/or in one or more cloud(s). The sustainability service 220 is implemented network and computing equipment. The sustainability service 220 communicates with the external entity 210 using API calls, for example, to obtain power supply information.

In one example embodiment, the sustainability service 220 may use and/or include the forecast generator 114 of FIG. 1 to generate time-series energy baselines for each of the first computing resource group 230a and the second computing resource group 230b (such as the first baseline 130a and the second baseline 130b of FIG. 1). As noted above, the forecast generator 114 calculates one or more attributes or parameters in the power supply information and generates time-series energy baseline. By way of a non-limiting example, the forecast generator 114 may determine that there is a seasonality parameter and use FFT to calculate the frequency of seasonality for renewable energy sources and non-renewable power sources for each computing resource group. This seasonality parameter is then used with fb-prophet to forecast power usage for any given time of day and day of the year.

The sustainability service 220 uses the power supply information related to a combination of power sources to determine, while AI/ML model is being trained using a current computing resource group (e.g., the first computing resource group 230a) of the at least two computing resource groups, an availability of power provided to the current computing resource group from one or more renewable energy sources. The sustainability service 220 migrates the AI/ML model for training using a different computing resource group (e.g., the second computing resource group 230b) than the current computing resource group, based on determining a lack of the availability of power provided to the current computing resource group from the one or more renewable energy sources.

In one example embodiments, the first computing resource group 230a and the second computing resource group 230b are distributed data centers, that are typical for large enterprises as they provide redundancy, cost efficiency, and higher operational efficiency. In another example embodiment, the first computing resource group 230a and the second computing resource group 230b are remote enterprise sites of a distributed data center. In yet another example embodiment, the first computing resource group 230a and the second computing resource group 230b are network and computing equipment sets in a data center. These are just some examples of the first computing resource group 230a and the second computing resource group 230b and the disclosure is not limited thereto.

Each of the first computing resource group 230a and the second computing resource group 230b include a training service 232, a training data set storage 234, a neural network 236 (an example of AI/ML model), and a checkpoint storage 238.

The training service 232 is configured to control training of the neural network 236. The training service 232 feeds a dataset from the training data set storage 234 to the neural network 236 for training. After a predetermined number of iterations in training the neural network 236, a result data set is stored in the checkpoint storage 238 i.e., the state of the neural network 236.

Training of artificial intelligence or machine learning models (e.g., neural networks, generative pre-trained transformers (GPTs), deep learning models, or large language models (LLMs)) using large datasets may take days and/or weeks. If the computing device or equipment such as the GPUs and/or the TPUs on which training is being performed fail, multiple days of work (training) may be lost. Hence, training AI/ML models such as neural networks, GPTs, deep learning models, or LLMs, involves checkpointing. Checkpointing is a mechanism to preserve the state and make forward progress even when system failures occur. Checkpointing involves storing a result data set in the checkpoint storage 238 after a predetermined number of iterations. The checkpointing varies depending on the type of AI/ML model, respective computing resource group, and/or user preferences. The checkpointing may occur after a predetermined number of iterations in training the neural network 236 e.g., each iteration, every two iterations, etc. At 239, the training service determines whether to continue the training using same computing resource group (e.g., run in the same site).

The training service 232 is further configured to communicate with the sustainability service 220. For example, the training service 232 registers its computing resource group with the sustainability service 220. Specifically, when a new computing resource group is to train the neural network 236, the training service 232 related to this new computing resource group sends a registration request to the sustainability service 220. In response, the sustainability service 220 copies a training dataset used for training the neural network 236 into the training data set storage 234 of the new computing resource group. Further, if the sustainability service 220 does not have power supply information for a particular location (i.e., the new computing resource group), the sustainability service 220 fetches the power supply information from a respective source e.g., the external entity 210. In one example, the sustainability service 220 may fetch power supply information for a predetermined time period (e.g., one month) to generate a time-series energy baseline related to the new computing resource group. Using the power supply information, the sustainability service 220 determines a target computing resource group to run the training of the neural network 236 when the training process starts. Additionally, the training service 232 is configured to inform the sustainability service 220 when the training is at a checkpoint and/or when requested by the sustainability service 220.

The training service 232 is further configured to facilitate migration of the neural network 236 to a different computing resource group when requested by the sustainability service 220 Specifically, the training service 232 provides the result data set from the checkpoint storage 238 to the different computing resource group, at the instructions of the sustainability service 220.

The neural network 236 is just one non-limiting example of AI/ML model. The AI/ML model may be a generative pre-trained transformer (GPT) model, a deep learning model, a large language model (LLM), etc. The size of the AI/ML models may range from multiple megabytes to gigabytes in size. However, in comparison to the energy used to train AI/ML models, the energy required to move these AI/ML models (the result data set) is negligible.

A table set forth below illustrates sizes of example AI/ML models and energy required to transfer these AI/ML models, according to an example embodiment.

| | | | | CO2 | CO2 |
|---|---|---|---|---|---|
| | | | Energy in | footprint to | footprint to |
| | Parameter | | Joules | transfer | train model |
| Model | Count (in | | required for | (Kgs of CO2 | (Kg of CO2 |
| Type | Billion) | Size | transfer | emissions) | emitted) |
| Resnet | 0.2 | 100 Mb | 0.08 | Negligible | 0.17 |
| Llama | 65 | 8 GB | 6.4 | 0.0000028 | 86.18 (21 days |
| | | | | | training) |
| GPT-3 | 175 | 800 GB | 640 | 0.00028 | 531775.8 (355 |
| | | | | | years of |
| | | | | | training) |

Specifically, the table includes Resnet, Llama, and GPT-3, parameter count in billion, size of the respective AI/ML model, energy required to transfer the model (in Joules), carbon (CO2) footprint for transferring the AI/ML model in Kg of CO2 emissions, and C02 footprint for training the AI/ML model in Kg of CO2 emissions.

For example, 10 pico Joule are used to transfer 1 bit over ethernet and it is 8 times more efficient over an optical fiber. Generally, datacenters are connected over optical fibers when data transfer happens over the Internet. For example, each bit traverses 10 hops (ethernet interfaces) to reach the destination. As such, one hundred pico Joules are used to transfer 1 bit of data from one datacenter to another (e.g., from one location to another of a distributed data center). Meanwhile training of AI/ML model such as GPT3 model on a single GPU may take over three hundred years, resulting in a carbon footprint of approximately 531775 KG CO2 emissions.

The table illustrates that the carbon footprint for training AI/ML models can be quite high, whereas the energy involved to transfer the AI/ML model to a different datacenter location (i.e., a different computing resource group) with a 10 hop connectivity is negligible in comparison. Even for models as large as GPT-3, the carbon emissions to transfer the data of the AI/ML model are negligible compared to the savings that is being achieved by training the AI/ML models at locations where renewable energy sources are powering the data centers. In one example embodiment, the entire AI/ML model may be transferred (e.g., the entire results data set). In yet another example embodiment, by using efficient replication strategies, the size of data replication may be decreased much further to provide even more energy savings.

The dataset stored in the training data set storage 234 used for training the neural network 236 may remain constant across thousands of iterations of training. As such, the dataset is replicated or copied to each computing resource group that is registered to participate in the training process. In the table above, it was shown that the carbon footprint for data transfer is negligible compared to the carbon emissions for training an AI/ML model in GPUs. Further, after each iteration, the training results (results data set) are checkpointed and stored in the checkpoint storage 238. The checkpoint storage 238 may be a cross datacenter replicated persistent storage. Energy involved in transferring the results data set is also negligible.

In one example embodiment, the sustainability service 220 sets a deadline (e.g., a time-window, a time interval, or a particular point in time) at which the training service 232 is to finish the task e.g., one or more iterations of training the neural network 236. If the training is not finished within the set deadline, the training service 232 checkpoints the latest state of the neural network 236 (stores the results data set in the checkpoint storage 238) and reports to the sustainability service 220 whether it finished training or not. If the training of the neural network 236 needs to be continued, then the sustainability service 220 selects the best computing resource group to continue the training based on sustainability metrics. Migration of the neural network 236 to a different computing resource group to continue training occurs at a checkpoint.

Specifically, the sustainability service 220 determines an availability of power provided to the current computing resource group (e.g., the first computing resource group 230a) from one or more renewable energy sources based on the power supply information. The sustainability service 220 may determine to continue training the neural network 236 at the first computing resource group 230a based on the power supply from the renewable energy sources being above a predetermined threshold value or more than a particular percentage (e.g., run in the same site at 239). The sustainability service 220 then instructs the training service 232 to continue training the neural network 236, shown at 242.

On the other hand, if the sustainability service 220 determines that the first computing resource group 230a lacks power from renewable energy sources, the sustainability service 220 may decide to migrate the neural network 236 to a different computing resource group (e.g., the second computing resource group 230b) or stop training the neural network 236.

For example, if power supplied from renewable power sources to the first computing resource group 230a falls below a predetermined threshold value or lower by a predetermined value, the sustainability service 220 instructs the training service 232 to stop training the neural network 236. In other words, the AI/ML model may be shut down or training may be stopped while power from renewable energy sources is not available at the target location and/or at any of the other locations (other registered computing resource groups). In one example embodiment, the sustainability service 220 aims to avoid training the neural network 236 using power from non-renewable power sources.

The sustainability service 220 may select a computing resource group with the highest amount of renewable energy at a present time, a particular point in time, or based on future predictions (baselining). Specifically, if renewable energy source supplies power at a different location e.g., the second computing resource group 230b, at 246, the sustainability service 220 instructs the training service 232 related to the first computing resource group 230a to migrate training of the neural network 236 to the second computing resource group 230b. The results data set 244 is then copied to the checkpoint storage 238 of the second computing resource group 230b. At 246, the sustainability service 220 then instructs the training service 232 related to the second computing resource group 230b to continue training the neural network 236.

With continued reference to FIGS. 1 and 2, FIG. 3 is a flowchart illustrating a method 300 of determining, by a sustainability service, whether to continue training of an artificial intelligence or machine learning model at a current datacenter based on availability of power from one or more renewable energy sources, according to an example embodiment. The method 300 involves the sustainability service 220 and the training service 232 of FIG. 2 related to a computing resource group that is being used to train an AI/ML model. The computing resource groups are geographically remote datacenters, according to an example embodiment.

At 302, to start trainings the AI/ML model, the sustainability service 220 selects a datacenter (DC) i.e., a computing resource group. Specifically, the sustainability service 220 determines a first portion of power from the one or more renewable energy sources supplied to a current DC and determines a second portion of power from the one or more renewable energy sources supplied to a different DC and when the first portion is lower by a predetermined value than the second portion, the sustainability service 220 may select the different DC for training the AI/ML model. At 304, the sustainability service 220 instructs the training service of the current DC whether it should continue training or copy the results data set to a different DC i.e., migration occurs.

At 306, the training service 232 related to the current DC determines, based on the instructions from the sustainability service 220, whether to continue training the AI/ML model. If yes, the training service 232 continues training the AI/ML model until instructed otherwise by the sustainability service 220. If no, at 308, the training service copies the results data set to the destination DC specified by the sustainability service 220 and informs the sustainability service 220 when replication is complete. Specifically, if the sustainability service 220 determines to migrate the training of AI/ML model to a different computing resource group, the training service 232 transfers the checkpointed AI/ML model to the destination DC. When transfer is complete, the sustainability service 220 informs the newly selected training service related to the destination DC to continue training the AI/ML model by giving the newly selected training service a new deadline (time window) to finish.

This process continues until the AI/ML model is fully trained. Checkpoints typically occur after every iteration, after a fixed number (a predetermined threshold number) of iterations, or at the midpoint of an iteration, according to various example embodiments. After performing the checkpoint, the results data set is written to storage. Then using amount of renewable energy as it relates to the total power supplied or when amount of renewable energy falls lower than a predetermined value or below a threshold with respect to other computing resource groups, the sustainability service 220 may migrate the AI/ML model to a different computing group and continue training.

Training AI/ML models such as LLMs or DNN is resource intensive and carbon footprint of training is high. By intelligently selecting (based on sustainability metrics) a computing resource group from multiple resource groups in a distributed environment for training the AI/ML model, the sustainability service 220 reduces the carbon footprint of the enterprise.

For example, power supply from a combination of renewable energy sources and non-renewable power sources has seasonality over the day and over the year. At some locations, during daytime, the composition of renewable energy is >95% and as the night dawns, the non-renewable power sources dominate the power supply combination. By intelligently selecting locations where renewable energy is the highest among available computing resource groups, carbon footprint is decreased. The energy involved for data transfer and an auxiliary functionality of decision making by the sustainability service 220 is negligible in comparison to power/energy savings.

In one example embodiment, the sustainability service 220 may further determine an optimal renewable energy source among total available renewable energy sources and intelligently select a computing resource group powered by the optimal renewable energy source. Moreover, when power from renewable energy sources is not available, the sustainability service 220 may select an optimal or preferred non-renewable energy source and then continue training using the computing resource group that is powered by the preferred non-renewable energy source.

The techniques presented herein provide a sustainability service that trains AI/ML models based on energy supply patterns to reduce the carbon footprint by selecting locations powered by renewable energy sources. The sustainability service may determine percentage of total power supplied that is from renewable energy source(s) versus non-renewable power sources and based on the foregoing, determine whether to continue training the AI/ML model at a currently location (computing resource group) or move to a different location to reduce the carbon footprint. From the perspective of sustainability, the techniques presented herein reduce the carbon footprint.

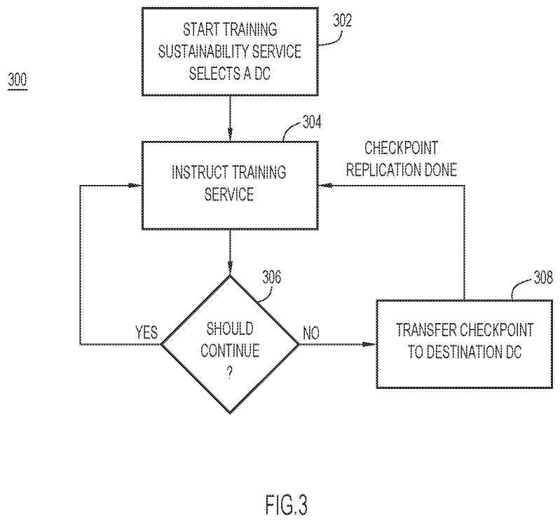

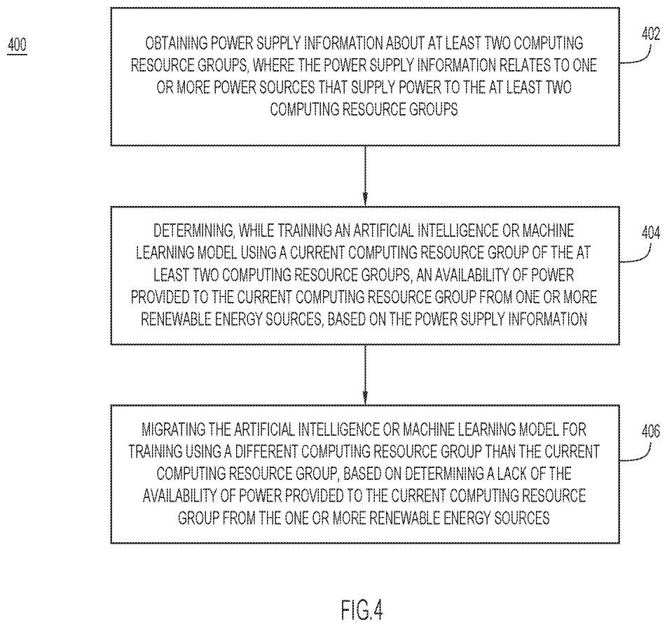

FIG. 4 is a flowchart illustrating a computer-implemented method 400 of migrating an artificial intelligence or machine learning model to a different resource group based on sustainability metric, according to an example embodiment. The computer-implemented method 400 may be performed by a computing device such as a server or a group of servers e.g., the sustainability service 220 and training services of FIGS. 2 and 3.

The computer-implemented method 400 involves, at 402, obtaining power supply information about at least two computing resource groups. The power supply information relates to one or more power sources that supply power to the at least two computing resource groups.

The computer-implemented method 400 further involve, at 404, determining, while training an artificial intelligence or machine learning model using a current computing resource group of the at least two computing resource groups, an availability of power provided to the current computing resource group from one or more renewable energy sources, based on the power supply information.

The computer-implemented method 400 further involves at 406, migrating the artificial intelligence or machine learning model for training using a different computing resource group than the current computing resource group, based on determining a lack of the availability of power provided to the current computing resource group from the one or more renewable energy sources.

According to one or more example embodiments, the artificial intelligence or machine learning model may be one of a neural network, a generative pre-trained transformer (GPT) model, a deep learning model, or a large language model (LLM). The computer-implemented method 400 may further involve training the artificial intelligence or machine learning model using the current computing resource group while determining that power supplied to the current computing resource group is from the one or more renewable energy sources.

In one form, in the computer-implemented method 400, the at least two computing resource groups may be a plurality of geographically remote enterprise sites of a distributed data center. Each of the plurality of geographically remote enterprise sites may include at least one of a plurality of graphics processing units or a plurality of tensor processing units for training one or more learning models.

In another form, the at least two computing resource groups may be a plurality of data centers that host network and computing equipment for performing hosting and computing functions.

In one instance, the operation 402 of obtaining the power supply information about the at least two computing resource groups may include obtaining time-series data about the one or more power sources that supply the power to a respective computing resource group of the at least two computing resource groups and generating a time-series energy baseline for the respective computing resource group. The time-series energy baseline may indicate a first portion of power supplied by the one or more renewable energy sources and a second portion of power supplied by one or more non-renewable energy sources of a total power supplied to the respective computing resource group at a particular point in time.

According to one or more example embodiments, the operation 404 of determining the availability of power from the one or more renewable energy sources provided to the current computing resource group may be based on the time-series energy baseline. The operation 406 of migrating the artificial intelligence or machine learning model may be based on determining that the first portion is below a predetermined threshold.

In one instance, the operation 402 of obtaining the power supply information about the at least two computing resource groups may include performing an application programming interface (API) call to an external entity to obtain data about a portion of a total power supplied by each of a plurality of power supply sources that power a respective computing resource group.

In one form, the operation 404 of determining the availability of power from the one or more renewable energy sources provided to the current computing resource group may include determining a first portion of power from the one or more renewable energy sources supplied to the current computing resource group and determining a second portion of power from the one or more renewable energy sources supplied to the different computing resource group. The operation 406 of migrating the artificial intelligence or machine learning model may be based on the first portion being lower by a predetermined value than the second portion.

In another form, the operation 406 of migrating the artificial intelligence or machine learning model may include transferring, from a first storage associated with the current computing resource group to a second storage associated with the different computing resource group, a result data set that includes a state of the artificial intelligence or machine learning model and instructing the different computing resource group to continue training the artificial intelligence or machine learning model using the result data set.

In yet another form, the operation 406 of determining may be performed at a checkpoint that occurs after a predetermined number of iterations in training the artificial intelligence or machine learning model.

According to one or more example embodiments, the computer-implemented method 400 may further involve setting a time interval for determining the availability of power from the one or more renewable energy sources and obtaining, from the current computing resource group, an indication of whether training of the artificial intelligence or machine learning model is at a checkpoint based on the time interval. The operation 406 of migrating may occur when the artificial intelligence or machine learning model is at the checkpoint.

In the computer-implemented method 400, the at least two computing resource groups may include a new computing resource group. The computer-implemented method 400 may further include obtaining a request for registering the new computing resource group, obtaining additional power supply information for the new computing resource group, and copying a dataset for training the artificial intelligence or machine learning model to a storage associated with the new computing resource group.

FIG. 5 is a hardware block diagram of a computing device 500 that may perform functions associated with any combination of operations in connection with the techniques depicted in FIGS. 1-4, according to various example embodiments, including, but not limited to, operations of the computing device or one or more servers that execute forecast generator 114 of FIG. 1, the sustainability service 220 of FIGS. 2 and 3, the training service 232 of FIGS. 2 and 3, and/or one of its components. Further, the computing device 500 may be representative of one of network devices, network and computing equipment, or a hardware of an enterprise. It should be appreciated that FIG. 5 provides only an illustration of one example embodiment and does not imply any limitations with respect to the environments in which different example embodiments may be implemented. Many modifications to the depicted environment may be made.

In at least one embodiment, computing device 500 may include one or more processor(s) 502, one or more memory element(s) 504, storage 506, a bus 508, one or more network processor unit(s) 510 interconnected with one or more network input/output (I/O) interface(s) 512, one or more I/O interface(s) 514, and control logic 520. In various embodiments, instructions associated with logic for computing device 500 can overlap in any manner and are not limited to the specific allocation of instructions and/or operations described herein.

In at least one embodiment, processor(s) 502 is/are at least one hardware processor configured to execute various tasks, operations and/or functions for computing device 500 as described herein according to software and/or instructions configured for computing device 500. Processor(s) 502 (e.g., a hardware processor) can execute any type of instructions associated with data to achieve the operations detailed herein. In one example, processor(s) 502 can transform an element or an article (e.g., data, information) from one state or thing to another state or thing. Any of potential processing elements, microprocessors, digital signal processor, baseband signal processor, modem, PHY, controllers, systems, managers, logic, and/or machines described herein can be construed as being encompassed within the broad term ‘processor’.

In at least one embodiment, one or more memory element(s) 504 and/or storage 506 is/are configured to store data, information, software, and/or instructions associated with computing device 500, and/or logic configured for memory element(s) 504 and/or storage 506. For example, any logic described herein (e.g., control logic 520) can, in various embodiments, be stored for computing device 500 using any combination of memory element(s) 504 and/or storage 506. Note that in some embodiments, storage 506 can be consolidated with one or more memory elements 504 (or vice versa), or can overlap/exist in any other suitable manner.

In at least one embodiment, bus 508 can be configured as an interface that enables one or more elements of computing device 500 to communicate in order to exchange information and/or data. Bus 508 can be implemented with any architecture designed for passing control, data and/or information between processors, memory elements/storage, peripheral devices, and/or any other hardware and/or software components that may be configured for computing device 500. In at least one embodiment, bus 508 may be implemented as a fast kernel-hosted interconnect, potentially using shared memory between processes (e.g., logic), which can enable efficient communication paths between the processes.

In various embodiments, network processor unit(s) 510 may enable communication between computing device 500 and other systems, entities, etc., via network I/O interface(s) 512 to facilitate operations discussed for various embodiments described herein. In various embodiments, network processor unit(s) 510 can be configured as a combination of hardware and/or software, such as one or more Ethernet driver(s) and/or controller(s) or interface cards, Fibre Channel (e.g., optical) driver(s) and/or controller(s), and/or other similar network interface driver(s) and/or controller(s) now known or hereafter developed to enable communications between computing device 500 and other systems, entities, etc. to facilitate operations for various embodiments described herein. In various embodiments, network I/O interface(s) 512 can be configured as one or more Ethernet port(s), Fibre Channel ports, and/or any other I/O port(s) now known or hereafter developed. Thus, the network processor unit(s) 510 and/or network I/O interface(s) 512 may include suitable interfaces for receiving, transmitting, and/or otherwise communicating data and/or information in a network environment.

I/O interface(s) 514 allow for input and output of data and/or information with other entities that may be connected to computing device 500. For example, I/O interface(s) 514 may provide a connection to external devices such as a keyboard, keypad, a touch screen, and/or any other suitable input device now known or hereafter developed. In some instances, external devices can also include portable computer readable (non-transitory) storage media such as database systems, thumb drives, portable optical or magnetic disks, and memory cards. In still some instances, external devices can be a mechanism to display data to a user, such as, for example, a display 516 such as a computer monitor, a display screen, or the like.

In various embodiments, control logic 520 can include instructions that, when executed, cause processor(s) 502 to perform operations, which can include, but not be limited to, providing overall control operations of computing device; interacting with other entities, systems, etc. described herein; maintaining and/or interacting with stored data, information, parameters, etc. (e.g., memory element(s), storage, data structures, databases, tables, etc.); combinations thereof; and/or the like to facilitate various operations for embodiments described herein.

In another example embodiment, an apparatus is provided. The apparatus includes a memory, a network interface configured to enable network communications, and a processor. The processor is configured to perform a method that involves obtaining power supply information about at least two computing resource groups. The power supply information relates to one or more power sources that supply power to the at least two computing resource groups. The method further involves determining, while training an artificial intelligence or machine learning model using a current computing resource group of the at least two computing resource groups, an availability of power provided to the current computing resource group from one or more renewable energy sources, based on the power supply information and migrating the artificial intelligence or machine learning model for training using a different computing resource group than the current computing resource group, based on determining a lack of the availability of power provided to the current computing resource group from the one or more renewable energy sources.

In yet another example embodiment, one or more non-transitory computer readable storage media encoded with instructions are provided. When the media is executed by a processor, the instructions cause the processor to execute a method that includes obtaining power supply information about at least two computing resource groups. The power supply information relates to one or more power sources that supply power to the at least two computing resource groups. The method further involves determining, while training an artificial intelligence or machine learning model using a current computing resource group of the at least two computing resource groups, an availability of power provided to the current computing resource group from one or more renewable energy sources, based on the power supply information and migrating the artificial intelligence or machine learning model for training using a different computing resource group than the current computing resource group, based on determining a lack of the availability of power provided to the current computing resource group from the one or more renewable energy sources.

In yet another example embodiment, a system is provided that includes the devices and operations explained above with reference to FIGS. 1-5.

The programs described herein (e.g., control logic 520) may be identified based upon the application(s) for which they are implemented in a specific embodiment. However, it should be appreciated that any particular program nomenclature herein is used merely for convenience, and thus the embodiments herein should not be limited to use(s) solely described in any specific application(s) identified and/or implied by such nomenclature.

In various embodiments, entities as described herein may store data/information in any suitable volatile and/or non-volatile memory item (e.g., magnetic hard disk drive, solid state hard drive, semiconductor storage device, random access memory (RAM), read only memory (ROM), erasable programmable read only memory (EPROM), application specific integrated circuit (ASIC), etc.), software, logic (fixed logic, hardware logic, programmable logic, analog logic, digital logic), hardware, and/or in any other suitable component, device, element, and/or object as may be appropriate. Any of the memory items discussed herein should be construed as being encompassed within the broad term ‘memory element’. Data/information being tracked and/or sent to one or more entities as discussed herein could be provided in any database, table, register, list, cache, storage, and/or storage structure: all of which can be referenced at any suitable timeframe. Any such storage options may also be included within the broad term ‘memory element’ as used herein.

Note that in certain example implementations, operations as set forth herein may be implemented by logic encoded in one or more tangible media that is capable of storing instructions and/or digital information and may be inclusive of non-transitory tangible media and/or non-transitory computer readable storage media (e.g., embedded logic provided in: an ASIC, digital signal processing (DSP) instructions, software [potentially inclusive of object code and source code], etc.) for execution by one or more processor(s), and/or other similar machine, etc. Generally, the storage 506 and/or memory elements(s) 504 can store data, software, code, instructions (e.g., processor instructions), logic, parameters, combinations thereof, and/or the like used for operations described herein. This includes the storage 506 and/or memory elements(s) 504 being able to store data, software, code, instructions (e.g., processor instructions), logic, parameters, combinations thereof, or the like that are executed to carry out operations in accordance with teachings of the present disclosure.

In some instances, software of the present embodiments may be available via a non-transitory computer useable medium (e.g., magnetic or optical mediums, magneto-optic mediums, CD-ROM, DVD, memory devices, etc.) of a stationary or portable program product apparatus, downloadable file(s), file wrapper(s), object(s), package(s), container(s), and/or the like. In some instances, non-transitory computer readable storage media may also be removable. For example, a removable hard drive may be used for memory/storage in some implementations. Other examples may include optical and magnetic disks, thumb drives, and smart cards that can be inserted and/or otherwise connected to a computing device for transfer onto another computer readable storage medium.

Embodiments described herein may include one or more networks, which can represent a series of points and/or network elements of interconnected communication paths for receiving and/or transmitting messages (e.g., packets of information) that propagate through the one or more networks. These network elements offer communicative interfaces that facilitate communications between the network elements. A network can include any number of hardware and/or software elements coupled to (and in communication with) each other through a communication medium. Such networks can include, but are not limited to, any local area network (LAN), virtual LAN (VLAN), wide area network (WAN) (e.g., the Internet), software defined WAN (SD-WAN), wireless local area (WLA) access network, wireless wide area (WWA) access network, metropolitan area network (MAN), Intranet, Extranet, virtual private network (VPN), Low Power Network (LPN), Low Power Wide Area Network (LPWAN), Machine to Machine (M2M) network, Internet of Things (IoT) network, Ethernet network/switching system, any other appropriate architecture and/or system that facilitates communications in a network environment, and/or any suitable combination thereof.

Networks through which communications propagate can use any suitable technologies for communications including wireless communications (e.g., 4G/5G/nG, IEEE 802.11 (e.g., Wi-Fi®/Wi-Fi6®), IEEE 802.16 (e.g., Worldwide Interoperability for Microwave Access (WiMAX)), Radio-Frequency Identification (RFID), Near Field Communication (NFC), Bluetooth™ mm.wave, Ultra-Wideband (UWB), etc.), and/or wired communications (e.g., T1 lines, T3 lines, digital subscriber lines (DSL), Ethernet, Fibre Channel, etc.). Generally, any suitable means of communications may be used such as electric, sound, light, infrared, and/or radio to facilitate communications through one or more networks in accordance with embodiments herein. Communications, interactions, operations, etc. as discussed for various embodiments described herein may be performed among entities that may directly or indirectly connected utilizing any algorithms, communication protocols, interfaces, etc. (proprietary and/or non-proprietary) that allow for the exchange of data and/or information.

Communications in a network environment can be referred to herein as ‘messages’, ‘messaging’, ‘signaling’, ‘data’, ‘content’, ‘objects’, ‘requests’, ‘queries’, ‘responses’, ‘replies’, etc. which may be inclusive of packets. As referred to herein, the terms may be used in a generic sense to include packets, frames, segments, datagrams, and/or any other generic units that may be used to transmit communications in a network environment. Generally, the terms reference to a formatted unit of data that can contain control or routing information (e.g., source and destination address, source and destination port, etc.) and data, which is also sometimes referred to as a ‘payload’, ‘data payload’, and variations thereof. In some embodiments, control or routing information, management information, or the like can be included in packet fields, such as within header(s) and/or trailer(s) of packets. Internet Protocol (IP) addresses discussed herein and in the claims can include any IP version 4 (IPv4) and/or IP version 6 (IPv6) addresses.

To the extent that embodiments presented herein relate to the storage of data, the embodiments may employ any number of any conventional or other databases, data stores or storage structures (e.g., files, databases, data structures, data, or other repositories, etc.) to store information.

Note that in this Specification, references to various features (e.g., elements, structures, nodes, modules, components, engines, logic, steps, operations, functions, characteristics, etc.) included in ‘one embodiment’, ‘example embodiment’, ‘an embodiment’, ‘another embodiment’, ‘certain embodiments’, ‘some embodiments’, ‘various embodiments’, ‘other embodiments’, ‘alternative embodiment’, and the like are intended to mean that any such features are included in one or more embodiments of the present disclosure, but may or may not necessarily be combined in the same embodiments. Note also that a module, engine, client, controller, function, logic or the like as used herein in this Specification, can be inclusive of an executable file comprising instructions that can be understood and processed on a server, computer, processor, machine, compute node, combinations thereof, or the like and may further include library modules loaded during execution, object files, system files, hardware logic, software logic, or any other executable modules.

It is also noted that the operations and steps described with reference to the preceding figures illustrate only some of the possible scenarios that may be executed by one or more entities discussed herein. Some of these operations may be deleted or removed where appropriate, or these steps may be modified or changed considerably without departing from the scope of the presented concepts. In addition, the timing and sequence of these operations may be altered considerably and still achieve the results taught in this disclosure. The preceding operational flows have been offered for purposes of example and discussion. Substantial flexibility is provided by the embodiments in that any suitable arrangements, chronologies, configurations, and timing mechanisms may be provided without departing from the teachings of the discussed concepts.

As used herein, unless expressly stated to the contrary, use of the phrase ‘at least one of’, ‘one or more of’, ‘and/or’, variations thereof, or the like are open-ended expressions that are both conjunctive and disjunctive in operation for any and all possible combination of the associated listed items. For example, each of the expressions ‘at least one of X, Y and Z’, ‘at least one of X, Y or Z’, ‘one or more of X, Y and Z’, ‘one or more of X, Y or Z’ and ‘X, Y and/or Z’ can mean any of the following: 1) X, but not Y and not Z; 2) Y, but not X and not Z; 3) Z, but not X and not Y; 4) X and Y, but not Z; 5) X and Z, but not Y; 6) Y and Z, but not X; or 7) X, Y, and Z.

Additionally, unless expressly stated to the contrary, the terms ‘first’, ‘second’, ‘third’, etc., are intended to distinguish the particular nouns they modify (e.g., element, condition, node, module, activity, operation, etc.). Unless expressly stated to the contrary, the use of these terms is not intended to indicate any type of order, rank, importance, temporal sequence, or hierarchy of the modified noun. For example, ‘first X’ and ‘second X’ are intended to designate two ‘X’ elements that are not necessarily limited by any order, rank, importance, temporal sequence, or hierarchy of the two elements. Further as referred to herein, ‘at least one of’ and ‘one or more of’ can be represented using the ‘(s)’ nomenclature (e.g., one or more element(s)).

Each example embodiment disclosed herein has been included to present one or more different features. However, all disclosed example embodiments are designed to work together as part of a single larger system or method. This disclosure explicitly envisions compound embodiments that combine multiple previously discussed features in different example embodiments into a single system or method.

One or more advantages described herein are not meant to suggest that any one of the embodiments described herein necessarily provides all of the described advantages or that all the embodiments of the present disclosure necessarily provide any one of the described advantages. Numerous other changes, substitutions, variations, alterations, and/or modifications may be ascertained to one skilled in the art and it is intended that the present disclosure encompass all such changes, substitutions, variations, alterations, and/or modifications as falling within the scope of the appended claims.

What is claimed is:

1. A computer-implemented method comprising:
obtaining power supply information about at least two computing resource groups, wherein the power supply information relates to one or more power sources that supply power to the at least two computing resource groups;
determining, while training an artificial intelligence or machine learning model using a current computing resource group of the at least two computing resource groups, an availability of power provided to the current computing resource group from one or more renewable energy sources, based on the power supply information; and
migrating the artificial intelligence or machine learning model for training using a different computing resource group than the current computing resource group, based on determining a lack of the availability of power provided to the current computing resource group from the one or more renewable energy sources.

2. The computer-implemented method of claim 1, wherein the artificial intelligence or machine learning model is one of a neural network, a generative pre-trained transformer (GPT) model, a deep learning model, or a large language model (LLM), and further comprising:
training the artificial intelligence or machine learning model using the current computing resource group while determining that power supplied to the current computing resource group is from the one or more renewable energy sources.

3. The computer-implemented method of claim 1, wherein the at least two computing resource groups are a plurality of geographically remote enterprise sites of a distributed data center, each of the plurality of geographically remote enterprise sites including at least one of a plurality of graphics processing units or a plurality of tensor processing units for training one or more learning models.

4. The computer-implemented method of claim 1, wherein the at least two computing resource groups are a plurality of data centers that host network and computing equipment for performing hosting and computing functions.

5. The computer-implemented method of claim 1, wherein obtaining the power supply information about the at least two computing resource groups includes:
obtaining time-series data about the one or more power sources that supply the power to a respective computing resource group of the at least two computing resource groups; and
generating a time-series energy baseline for the respective computing resource group, wherein the time-series energy baseline indicates a first portion of power supplied by the one or more renewable energy sources and a second portion of power supplied by one or more non-renewable energy sources of a total power supplied to the respective computing resource group at a particular point in time.

6. The computer-implemented method of claim 5, wherein determining the availability of the power from the one or more renewable energy sources provided to the current computing resource group is based on the time-series energy baseline, and wherein migrating is based on determining that the first portion is below a predetermined threshold.

7. The computer-implemented method of claim 1, wherein obtaining the power supply information about the at least two computing resource groups includes:
performing an application programming interface (API) call to an external entity to obtain data about a portion of a total power supplied by each of a plurality of power supply sources that power a respective computing resource group.

8. The computer-implemented method of claim 1, wherein determining the availability of power from the one or more renewable energy sources provided to the current computing resource group includes:
determining a first portion of power from the one or more renewable energy sources supplied to the current computing resource group; and
determining a second portion of power from the one or more renewable energy sources supplied to the different computing resource group,
wherein migrating is based on the first portion being lower by a predetermined value than the second portion.

9. The computer-implemented method of claim 1, wherein migrating includes:
transferring, from a first storage associated with the current computing resource group to a second storage associated with the different computing resource group, a result data set that includes a state of the artificial intelligence or machine learning model; and
instructing the different computing resource group to continue training the artificial intelligence or machine learning model using the result data set.

10. The computer-implemented method of claim 1, wherein determining is performed at a checkpoint that occurs after a predetermined number of iterations in training the artificial intelligence or machine learning model.

11. The computer-implemented method of claim 1, further comprising:
setting a time interval for determining the availability of power from the one or more renewable energy sources;
obtaining, from the current computing resource group, an indication of whether training of the artificial intelligence or machine learning model is at a checkpoint based on the time interval, wherein migrating occurs when the artificial intelligence or machine learning model is at the checkpoint.

12. The computer-implemented method of claim 1, wherein the at least two computing resource groups includes a new computing resource group, and further comprising:
obtaining a request for registering the new computing resource group;
obtaining additional power supply information for the new computing resource group; and
copying a dataset for training the artificial intelligence or machine learning model to a storage associated with the new computing resource group.

13. An apparatus comprising:
a memory;
a network interface configured to enable network communications; and
a processor, wherein the processor is configured to perform a method comprising:
obtaining power supply information about at least two computing resource groups, wherein the power supply information relates to one or more power sources that supply power to the at least two computing resource groups;
determining, while training an artificial intelligence or machine learning model using a current computing resource group of the at least two computing resource groups, an availability of power provided to the current computing resource group from one or more renewable energy sources, based on the power supply information; and
migrating the artificial intelligence or machine learning model for training using a different computing resource group than the current computing resource group, based on determining a lack of the availability of power provided to the current computing resource group from the one or more renewable energy sources.

14. The apparatus of claim 13, wherein the artificial intelligence or machine learning model is one of a neural network, a generative pre-trained transformer (GPT) model, a deep learning model, or a large language model (LLM), and the processor is further configured to perform:
training the artificial intelligence or machine learning model using the current computing resource group while determining that power supplied to the current computing resource group is from the one or more renewable energy sources.

15. The apparatus of claim 13, wherein the at least two computing resource groups are a plurality of geographically remote enterprise sites of a distributed data center, each of the plurality of geographically remote enterprise sites including at least one of a plurality of graphics processing units or a plurality of tensor processing units for training one or more learning models.

16. The apparatus of claim 13, wherein the at least two computing resource groups are a plurality of data centers that host network and computing equipment for performing hosting and computing functions.

17. The apparatus of claim 13, wherein the processor is configured to obtain the power supply information about the at least two computing resource groups by:
obtaining time-series data about the one or more power sources that supply the power to a respective computing resource group of the at least two computing resource groups; and
generating a time-series energy baseline for the respective computing resource group, wherein the time-series energy baseline indicates a first portion of power supplied by the one or more renewable energy sources and a second portion of power supplied by one or more non-renewable energy sources of a total power supplied to the respective computing resource group at a particular point in time.

18. One or more non-transitory computer readable storage media encoded with software comprising computer executable instructions that, when executed by a processor, cause the processor to perform a method including:
obtaining power supply information about at least two computing resource groups, wherein the power supply information relates to one or more power sources that supply power to the at least two computing resource groups;
determining, while training an artificial intelligence or machine learning model using a current computing resource group of the at least two computing resource groups, an availability of power provided to the current computing resource group from one or more renewable energy sources, based on the power supply information; and
migrating the artificial intelligence or machine learning model for training using a different computing resource group than the current computing resource group, based on determining a lack of the availability of power provided to the current computing resource group from the one or more renewable energy sources.

19. The one or more non-transitory computer readable storage media according to claim 18, wherein the artificial intelligence or machine learning model is one of a neural network, a generative pre-trained transformer (GPT) model, a deep learning model, or a large language model (LLM), and the computer executable instructions further cause the processor to perform:
training the artificial intelligence or machine learning model using the current computing resource group while determining that power supplied to the current computing resource group is from the one or more renewable energy sources.

20. The one or more non-transitory computer readable storage media according to claim 18, wherein the at least two computing resource groups are a plurality of geographically remote enterprise sites of a distributed data center, each of the plurality of geographically remote enterprise sites including at least one of a plurality of graphics processing units or a plurality of tensor processing units for training one or more learning models.
